(19) United States
(12) Patent Application Publication
(10) Pub. No.: US 2005/0073398 A1
(43) Pub. Date: Apr. 7, 2005

(54) Warning algorithms for vehicle driveline failures

(76) Inventors: Robert Anthony Sayman, Laurinburg, NC (US); James Henry DeVore, Laurinburg, NC (US); Ronald Peter Muetzel, Southern Pines, NC (US); Muneer Abusamra, Southern Pines, NC (US); Rupert Kramer, Friedrichshafen (DE)

Correspondence Address: CARLSON, GASKEY & OLDS, P.C., 400 WEST MAPLE ROAD, SUITE 350, BIRMINGHAM, MI, 48009, US

(21) Appl. No.: 10/668,514

(22) Filed: Sep. 23, 2003

(51) Int. Cl. B60Q 1/00

(52) U.S. Cl. 340/441

(57) ABSTRACT

The basic warning devices utilized in a vehicle driveline are improved. In particular, should a problem be detected with a clutch or transmission, it is known to actuate a primary warning device. However, the primary warning device itself may be subject to failure. If the primary warning device fails, then an operator of the vehicle may not be provided with an indication of an impending problem in a timely manner. The present invention monitors the operation of each primary warning device, and actuates a secondary warning device should the primary warning device fail. In another portion of this invention, a sensor senses the operation of an automatic clutch for clutch slippage. If clutch slippage occurs, then a warning is sent to the vehicle operator. If the vehicle operator does not take corrective measures, the clutch slippage can continue to occur over time. If the control determines that clutch slippage continues to occur, then the frequency of the warning is increased to provide a more insistent indication to the operator that some corrective measure should be taken.

### BACKGROUND OF THE INVENTION

This invention relates to improvement in warnings for various faults and/or failures in a vehicle driveline.

Vehicle drivelines are being provided with more and more electronic controls. As an example, sensors are included to detect various faults and/or failures, such as clutch slippage, transmission fluid levels, excessive temperature, etc. Other faults or undesired conditions are also sensed. The above listing is not intended to be a complete summary of all the potential faults and/or failures. Instead, the above list is merely exemplary.

Typically, various warning devices are incorporated into the cab of a vehicle. The warnings may be visual, such as a display panel or flashing light, or may be audio, such as a buzzer or some other audio warning.

Two problems exist with standard warnings. First, if the warning device itself has failed, then a slowly growing fault within the driveline could become more severe, and could result in damage to the vehicle. As an example, an early indication of a low fluid level or excessively high temperature, might provide the operator sufficient time to have maintenance performed on the vehicle before any permanent damage has occurred. However, if the primary warning device for displaying this undesired condition has failed, the operator may not learn of the undesired condition until the damage has occurred.

One other problem is that warning may sometimes be initially ignored by a vehicle operator. As an example, and in particular with regard to a slipping clutch, typically some warning is provided to the vehicle such as a light on a display panel. However, this intermittent warning may be ignored by the operator, and thus the operator does not take corrective as soon as would be desired. This can lead to damage to the clutch, such as an overload, etc. In these prior art warnings to provide an indication to the operator of a potential clutch slippage or overload included a visual indicator, or a change in the selected gear, or perhaps modification of a clutch engagement criteria.

### SUMMARY OF THE INVENTION

In disclosed embodiments of this invention, the two problems mentioned above are addressed. In a first algorithm, a control determines whether a primary warning system has failed. If so, then some secondary warning system is utilized in its place. In this manner, the operator is still provided with an indication of the undesired condition. Some table providing the operator with an indication of what a particular secondary warning is intended to imply may also be utilized.

In a second portion of this invention, if the operator ignores a clutch overload or slippage condition, the frequency of the warning increases. For example, should a buzzer be utilized as the warning, the frequency of the buzzer may increase. Alternatively, a warning on a dashboard may flash on and off at an increasing frequency, or lights can be dimmed or flashed in this same manner with increasing frequency.

In other embodiments, engine speed may be altered, and other steps such as applying engine brakes may be utilized. Further, an engine fault, an ABS fault or some other device fault can be utilized. Air may be vented from the brakes to prevent vehicle movement by actuating the parking brake. Some warning or display message may be utilized. The engine cooling fan can be turned on or off, or the engine itself may be simply shut down. Again, any of these various “secondary” methods may be utilized, however even this extensive list is merely exemplary, and other secondary warnings may be utilized.

These and other features of the present invention can be best understood from the following specification and drawings, the following of which is a brief description.

### BRIEF DESCRIPTION OF THE DRAWINGS

FIG. 1 is a schematic view of a vehicle driveline and warning system.

FIG. 2 is a flowchart of one aspect of this invention.

FIG. 3 is a flowchart of a second aspect of this invention.

### DETAILED DESCRIPTION OF THE PREFERRED EMBODIMENT

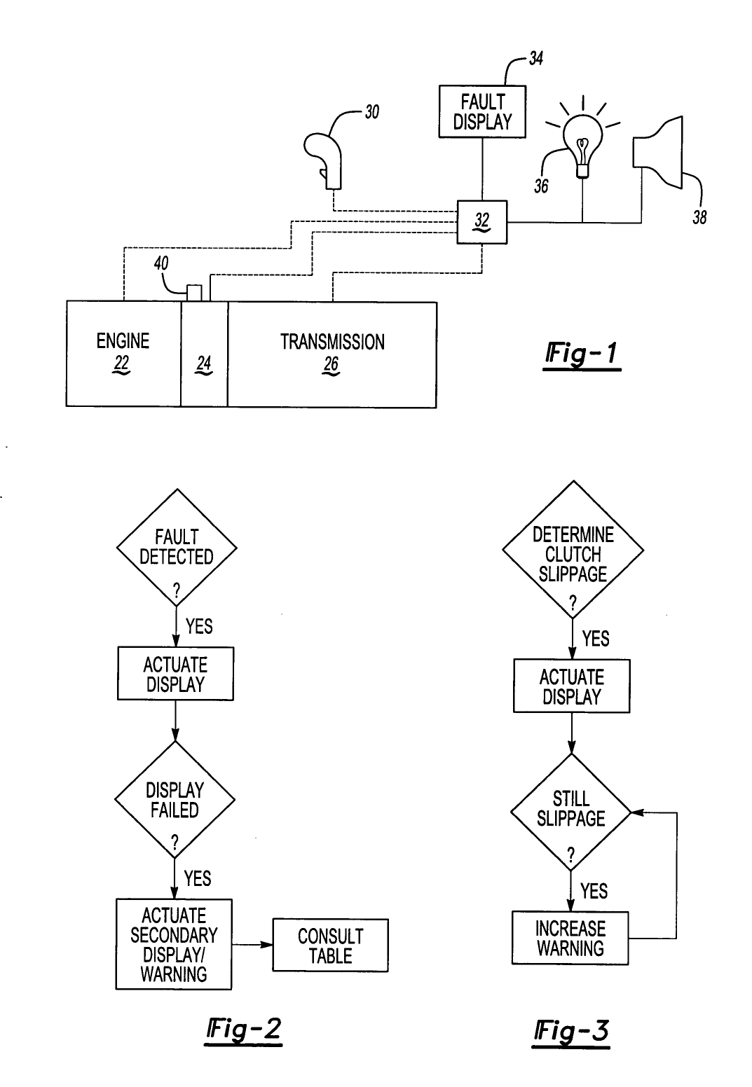

A vehicle driveline 20 is illustrated schematically in FIG. 1. As known, an engine 22 drives a clutch 24. The clutch is operable to move between open and closed positions and drive the transmission 26. The transmission 26 may be an automated transmission, an automatic transmission, or a pure manual transmission. If the transmission is pure manual or automated, then some operator input such as input lever 30 would be utilized to request a gear change at the transmission. A control 32 receives signals from the transmission 26, the clutch 24, the engine 20, and the lever 30. Various warning devices such as a display 34, a flashing light 36, or an audio warning 38 may be controlled by the control 32 based upon information supplied from sensors associated with the transmission 26, clutch 24 or engine 22.

As an example, a temperature sensor may be associated with the transmission. If temperature increases to an excessive amount, this might be indicative of a pending problem with the transmission. The control might then actuate a visual warning such as the display 34 indicating a fault. Typically, the visual warning may indicate the exact problem, such as transmission temperature. An operator provided with this warning then knows to seek maintenance before permanent damage can occur. However, one weak link in this chain is that the display 34 itself may fail. If the display 34 fails, then the operator is not provided with the early indication of the increase in temperature. The operator may thus continue to operate the vehicle not knowing that an impending problem is occurring in the transmission, and that permanent damage to the transmission could occur.

The FIG. 2 flowchart shows a first aspect of the invention, the control 32 monitors the operability of the display 34. If the control 32 finds that the display 34 has failed, then some secondary warning such as light 36, buzzer 38, or some control of the transmission 26 or engine 22 may be utilized to provide the operator this secondary warning level. As shown for example in FIG. 2, when a warning is to be sent, the control checks whether the primary warning device has failed. If so, then some secondary warning may be actuated. A table is provided that provides a list of available secondary warning device for a particular failure, and the operator of the vehicle may consult this table to determine what the actual failure is. Such a method could include a number of warnings being utilized in combination for the secondary warning for a particular failure such that the operator can determine the particular arrangement of secondary warnings, and then determine the actual fault which is being detected and for which the control 32 is seeking to provide a warning.

In other embodiments, engine speed may be altered, and other steps such as actuating engine brakes may be utilized. Further, an engine fault, an ABS fault or some other device fault can be utilized. Air may be vented from the brakes to prevent vehicle movement by actuating the parking brake. Some warning or display message may be utilized. The engine cooling fan can be turned on or off, or the engine itself may be simply shut down. Again, any of these various “secondary” methods may be utilized, however even this extensive list is merely exemplary, and other secondary warnings may be utilized.

FIG. 3 shows a second aspect of this invention, and one that may be utilized in combination with the first aspect, the operation of the clutch is monitored at step 40. If step 40 determines there is clutch slippage, or an impending overload on the clutch, then the display 34 is actuated. Clutch slippage is typically monitored by comparing an engine speed sensor reading and a transmission input shaft speed sensor reading. Of course, some clutch slippage is normal and acceptable. The warning of the invention is directed to excessive slippage. The display may have a light actuated periodically to let the operator know that slippage of the clutch is occurring. The operator should then take corrective action, as is known. If the control determines that the slippage still occurs after a period of time, then the frequency of the warning may increase. As an example, the light on display 34 may be actuated frequently, or if a buzzer is being utilized to send a warning that a clutch is slipping, the frequency of the warning sound could increase. While the increased frequency might be tied to the time over which the slippage occurs, the increase in frequency can also be proportional or somehow related to an increase in thermal energy in the clutch. As the clutch becomes hotter, the frequency could increase. Eventually, if the slipping has occurred for a good deal of time, the warning sound may become continuous.

This increase in frequency will provide a very clear indication to the operator that some corrective actions should occur.

While the two algorithms each stand on their own, they also have benefits when used in combination. That is, the warning on the clutch slippage could benefit from the provision of a secondary warning should the primary clutch slippage warning fail.

While a preferred embodiment of this invention has been disclosed, a worker of ordinary skill in this art would recognize that certain modifications would come within the scope of this invention. For that reason, the following claims should be studied to determine the true scope and content of this invention.

1. A vehicle driveline comprising:
at least one of a clutch and transmission;
a sensor for determining an undesired condition at said at least one of said clutch and said transmission, said sensor communicating with a control, said control communicating with a primary warning device to provide a warning to an operator of the vehicle of said undesired condition; and
said control being operable to monitor the operation of said primary warning device and actuate a secondary warning device should an indication be received that said primary warning device has failed.

2. A system as set forth in claim 1, wherein said vehicle driveline includes both a clutch and a transmission.

3. A system as set forth in claim 1, wherein said secondary warning is audio.

4. A system as set forth in claim 1, wherein said secondary warning is a visual warning.

5. A system as set forth in claim 1, wherein said secondary warning controls operation of a vehicle driveline component.

6. A system as set forth in claim 5, wherein said secondary warning includes actuation of one of said engine and a vehicle brake.

7. A system as set forth in claim 6, wherein the operation of said engine is controlled to provide said secondary warning.

8. A system as set forth in claim 6, wherein a vehicle brake system is actuated to provide said secondary warning.

9. A system as set forth in claim 1, wherein said sensor senses clutch slippage, and said primary warning is provided to an operator to provide an indication of said clutch slippage, and if said primary warning device fails, said secondary warning is then actuated.

10. A system as set forth in claim 9, wherein a pair of sensors sense engine speed and transmission input shaft speed to identify clutch slippage.

11. A vehicle driveline and warning system comprising:
a clutch, and a sensor for monitoring clutch slippage;
a control for receiving a signal from said sensor indicating a clutch slippage, said control communicating with a warning device to provide a warning to an operator of said clutch slippage; and
said control being operable to change said warning should said clutch slippage continue over time.

12. A system as set forth in claim 11, wherein said control increases the frequency of said warning if said clutch slippage continues to occur.

13. A system as set forth in claim 11, where said increase in frequency occurs if said clutch slippage continues to occur over time.

14. A system as set forth in claim 12, wherein said increase in frequency occurs if said clutch has an increasing temperature.

15. A method of providing a warning to the operator of a vehicle comprising the steps of:
(1) providing a vehicle driveline including a clutch and a transmission;
(2) monitoring operation of at least one of said clutch and said transmission, and detecting an undesired condition;
(3) providing an indication to a control of said undesired condition, and said control sending a message to a primary warning device to provide a warning to an operator, said control also monitoring the operability of said primary warning device; and
(4) said control actuating a secondary warning device if said control determines that said primary warning device has failed.

16. A method of operating a clutch comprising the steps of:
(1) monitoring a clutch for slippage, and providing a warning should slippage be detected;
(2) continuing to monitor said clutch for clutch slippage, and changing the nature of said warning should said clutch slippage continue to occur.

17. A method as set forth in claim 16, wherein said warning has a frequency that increases if said clutch slippage continues to occur over time.

18. A method as set forth in claim 16, wherein said change in the nature of said warning is an increase in the frequency of the warning should said clutch have an increasing temperature.
